(19) United States
(12) Patent Application Publication
(10) Pub. No.: US 2018/0220603 A1
(43) Pub. Date: Aug. 9, 2018

(54) INDUSTRIAL AEROPONICS

(71) Applicant: GEREK LEVI BURFORD, PRESCOTT VALLEY, AZ (US)

(72) Inventor: GEREK LEVI BURFORD, PRESCOTT VALLEY, AZ (US)

(21) Appl. No.: 15/870,939

(22) Filed: Jan. 13, 2018

Related U.S. Application Data
(60) Provisional application No. 62/446,545, filed on Jan. 16, 2017.

(51) Int. Cl. A01G 31/00; C05G 3/00; A01G 31/02; A01C 21/00; A01C 15/04

(52) U.S. Cl. CPC A01G 31/00; C05G 3/0064; A01G 2031/006; A01C 21/005; A01C 15/04; A01G 31/02

(57) ABSTRACT

The subsequent invention is in the technical fields of agriculture and biotechnology. More specifically the subsequent invention is in the technical field of aeroponics. An invention of industrial aeroponics comprising of delivering a precise pulse of an aerosol containing a colloid, or a solution, or a combination of a colloid and a solution to any living organism, a portion of a living organism, or to the tissue of an organism; wherein the aforementioned colloid, or solution, or combination of a colloid and a solution is constructed containing nutrients, or fertilizers, or a varying combination of the dispersed phase in the continuous phase, or a varying combination of solutes in a solvent, or a varying combination of the aforementioned. The pulse of aerosol is for a precise duration of time in a repeating manner as needed.

### CROSS-REFERENCE TO RELATED APPLICATIONS

Industrial Aeroponics

U.S. Pat. No. 6,244,6545

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

Not applicable

### BACKGROUND OF THE INVENTION

### 1) Field of the Invention

The subsequent invention is in the technical fields of agriculture and biotechnology. More specifically the subsequent invention is in the technical field of aeroponics.

### 2) Description of Related Art Including Information Disclosed Under 37 CFR 1.97 and 1.98

| Pat. No. | Title |
|---|---|
| 9,856,489 | Method for producing high-quality recombinant allergens in a plant |
| 9,848,545 | Growing systems and methods |
| 9,814,186 | Growing system |
| 9,810,673 | Cannabis cultivation test |
| 9,807,949 | Root environment control system and method |
| 9,803,222 | Processing biomass |
| 9,788,495 | Vertical aeroponic plant growing enclosure |
| 9,780,252 | Method and apparatus for reduction of solar cell LID |
| 9,745,609 | Processing biomass |
| 9,745,604 | Processing biomass |
| 9,743,665 | Fungicidal 3-{phenyl[heterocyclylmethoxy)imino]methyl}-oxadiazolone |
| | derivatives |
| 9,743,597 | Hydroponic rotating drum device for interiorly rooting and exteriorly growing |
| | plants |
| D795,130 | Aeroponic crop tower |
| 9,739,430 | Systems, methods and/or devices for providing LED lighting |
| 9,738,567 | Soluble fertilizer formulation and method for use thereof |
| 9,693,512 | Wireless sensor systems for hydroponics |
| 9,681,504 | Driver circuits with multiple rectifiers |
| 9,677,040 | Systems and methods of improved fermentation |
| 9,668,434 | Root misting system |
| 9,655,309 | Rooftop greenhouse inside roof infrastructure |
| 9,648,811 | Sequential and cyclic aeroponic system |
| 9,643,895 | Nutrient rich compositions |
| 9,642,370 | Bacteria and method for improving plant health and growth |
| 9,622,427 | Hydroponic system for growing plants |
| 9,622,426 | Method of improving the growth and production output of plants of the family |
| | Cannabaceae sensu stricto |
| 9,606,553 | SanSSoil (soil-less) indoor farming for food and energy production |
| 9,605,288 | Processing biomass |
| 9,605,287 | Processing biomass |
| 9,591,814 | Light-weight modular adjustable vertical hydroponic growing system and |
| | method |
| 9,587,258 | Processing biomass |
| 9,578,819 | Pressurized growing air system for vertical and horizontal planting systems |
| 9,568,458 | Optical sensor for fluid analysis |
| 9,565,812 | LED light timing in a high growth, high density, closed environment system |
| 9,556,158 | Fungicidal 3-[(pyridin-2-ylmethoxyimino)(phenyl)methyl]-2-substituted-1,2,-4- |
| | oxadiazol-5(2H)-one derivatives |
| 9,532,518 | Hydroponic growing system |
| 9,516,822 | Modular automated aeroponic growth system |
| 9,510,524 | Irrigation system |
| 9,491,915 | Vertical hydroponic plant production apparatus |
| 9,474,273 | Composition comprising an elicitor of the plant immune system |
| 9,474,217 | Controlled environment and method |
| 9,456,689 | Plant growing heavy weight bearing support assembly, apparatus and system |
| 9,439,989 | Disinfecting light fixture |
| 9,439,436 | Use of aryl carbamates in agriculture and other plant-related areas |
| 9,439,386 | Lettuce variety NUN 09051 LTL |
| 9,433,695 | Systems, apparatus, methods and articles for use in sanitization or disinfection |
| 9,433,160 | Hydroponic array for the individualized delivery of nutrients |
| 9,416,062 | Nutrient rich compositions |
| 9,410,258 | Systems and methods of improved fermentation |
| 9,408,391 | Fungicide composition comprising a tetrazolyloxime derivative and a |
| | thiazolylpiperidine derivative |
| 9,408,385 | Pesticidal composition comprising a pyridylethylbenzamide derivative and an |
| | insecticide compound |
| 9,382,633 | Systems and methods of improved fermentation |
| 9,380,756 | Lettuce variety multigreen 50 |
| 9,380,751 | Vertical hydroponic plant production apparatus |
| 9,375,010 | Fungicidal 3-{phenyl[(heterocyclylmethoxy)imino]methyl}-oxadiazolone |
| | derivatives |
| 9,374,953 | Vertical aeroponic plant growing enclosure with support structure |
| 9,359,265 | Plant nutrient coated nanoparticles and methods for their preparation and use |
| 9,357,715 | Vertical planter |
| 9,357,714 | Method for cultivating plants as well as a floating carrier |
| 9,345,207 | Commercial aeroponics system |
| 9,333,274 | Disinfecting light fixture |
| 9,326,515 | Fungicidal 3-[(1,3-thiazol-4-ylmethoxyimino)(phenyl)methyl]-2-substituted-- |
| | 1,2,4-oxadiazol-5(2H)-one derivatives |
| 9,309,545 | Processing biomass |
| 9,297,021 | MtNIP regulated plants with significantly increased size and biomass |
| 9,288,951 | Method and apparatus for aeroponic growth |
| 9,282,699 | Irrigation system |
| 9,279,101 | Systems and methods of improved fermentation |
| 9,259,771 | Methods of using hydrogen peroxide for in-situ chemical oxidation treatment of |
| | soil and groundwater |
| 9,247,688 | Nutrient blend optimization system |
| 9,241,454 | Lipochito-oligosaccharides stimulating arbuscular mycorrhizal symbiosis |
| 9,241,453 | Aeroponic commercial plant cultivation system utilizing a grow enclosure |
| 9,220,207 | Hydroponic produce display apparatus |
| 9,210,935 | Pesticide composition comprising fosetyl-aluminium, propamocarb-HCl and an |
| | insecticide active substance |
| 9,210,910 | Lettuce variety multired 54 |
| 9,210,846 | Vertical concentrated vegetable and plant grower |
| 9,198,396 | Lettuce variety NUN 06075 LTL |
| 9,198,395 | Lettuce variety multigreen 57 LTL |
| 9,175,258 | Microbial compositions and methods |
| 9,161,541 | Pesticide composition comprising propamocarb-hydrochloride and an |
| | insecticide active substance |
| 9,149,006 | Garden made EZ modular planter device |
| 9,144,223 | Lettuce variety multigreen 60 |
| 9,144,206 | Soil-free cultivation system |
| 9,131,685 | Compositions comprising a strigolactone compound and a chito-oligosaccharide |
| | compound for enhanced plant growth and yield |
| 9,127,244 | Digester assembly for providing renewable resources and associated systems, |
| | apparatuses, and methods |
| 9,125,417 | Pesticide composition comprising fosetyl-aluminium, propamocarb-HCl and an |
| | insecticide active substance |
| 9,125,408 | Use of aryl carbamates in agriculture and other plant-related areas |
| 9,125,351 | Plant cultivation device |
| 9,113,606 | Growing system for hydroponics and/or aeroponics |
| 9,090,600 | Fungicidal 4-substituted-3-{phenyl[(heterocyclylmethoxy)imino]methyl}-1,2,- |
| | 4-oxadizol-5(4H)-one derivatives |
| 9,078,461 | Processing biomass |
| 9,067,840 | Organic plant nutrient |
| 9,060,518 | Pesticide composition comprising a tetrazolyloxime derivative and a fungicide |
| | or an insecticide active substance |
| 9,000,012 | Fungicide hydroximoyl-heterocycles derivatives |
| 8,984,807 | Method and apparatus for aeroponic growth |
| 8,981,111 | Fungicide hydroximoyl-heterocycles derivatives |
| 8,980,602 | Processing biomass |
| 8,969,392 | Pesticide composition comprising propamocarb-fosetylate and an insecticidally |
| | active substance |
| 8,927,583 | Pesticidal composition comprising a 2-pyrdilmethylbenzamide derivative and an |
| | insecticide compound |
| 8,919,040 | Spiral garden |
| 8,919,038 | Irrigation system and method |
| 8,904,705 | Aeroponic system and sprayer device for improved plant growth and aeration |
| 8,881,454 | Agriculture production system with temperature controlled root zone |
| 8,877,684 | Pesticidal composition comprising a synthetic compound useful as nodulation |
| | agent of leguminous plants and an insecticide compound |
| 8,877,472 | Electron beam irradiation processing of biomass and saccharification thereof |
| 8,871,923 | Composition comprising an elicitor of the plant immune system |
| 8,851,457 | Low-turbulent aerator and aeration method |
| 8,841,101 | Processing biomass |
| 8,835,142 | Processing biomass |
| 8,796,512 | Lettuce variety multired 55 |
| 8,796,463 | Fungicide hydroximoyl-tetrazole derivatives |
| 8,785,729 | Lettuce variety redglace |
| 8,782,948 | Method and apparatus for aeroponic farming |
| 8,778,835 | Pesticidal composition comprising a pyridylethylbenzamide derivative and an |
| | insecticide compound |
| 8,765,452 | Flow tube reactor |
| 8,754,293 | Lettuce variety intred |
| 8,738,160 | Apparatus and method for plant metabolism manipulation using spectral output |
| 8,735,662 | Lettuce variety salmon |
| 8,728,779 | Processing biomass |
| 8,720,110 | Hydroponics equipment cleaning method |
| 8,637,284 | Processing biomass |
| 8,629,086 | Compositions and methods for the control of nematodes and soil borne diseases |
| 8,623,110 | Protein and isolated or purified amino acid product containing compositions and |
| | uses thereof |
| 8,621,782 | Mechanism for aeration and hydroponic growth of plant applications |
| 8,614,217 | Fungicide hydroximoyl-tetrazole derivatives |
| 8,580,799 | Fungicide hydroximoyl-heterocycles derivatives |
| 8,557,849 | Fungicide hydroximoyl-tetrazole derivatives |
| 8,544,207 | Hydroponic plant growth systems with activated carbon and/or carbonized fiber |
| | substrates |
| 8,533,993 | Modular vertical farm cell |
| 8,533,992 | Method and apparatus for aeroponic farming |
| 8,505,238 | Vertical aeroponic plant growing system |
| 8,492,388 | Fungicide hydroximoyl-tetrazole derivatives |
| 8,484,890 | Apparatus for aeroponically growing and developing plants |
| 8,468,741 | Semi-automated crop production system |
| 8,466,176 | Fungicide hydroximoyl-tetrazole derivatives |
| 8,443,546 | Hydroponic plant growing system |
| 8,440,591 | Pesticidal composition comprising synthetic compound useful as nodulation |
| | agent of leguminous plants and a fungicide compound |
| 8,418,401 | Photovoltaic greenhouse structure |
| 8,365,466 | Hydroponic produce display apparatus |
| 8,327,582 | Vertical hydroponic plant production apparatus |
| 8,324,177 | Triterpene compositions and methods for use thereof |
| 8,291,639 | Growing system for hydroponics and/or aeroponics |
| 8,288,426 | Pesticidal composition comprising fenamidone and an insecticide compound |
| 8,261,487 | Method and apparatus for growing plants |
| 8,261,486 | Systems and methods for controlling liquid delivery and distribution to plants |
| 8,256,382 | Method and system for managing animal waste in an animal breeding farm |
| 8,250,809 | Apparatus for aeroponically growing and developing plants |
| 8,236,830 | Pesticide composition comprising propamocarb-fosetylate and an insecticidally |
| | active substance |
| 8,225,549 | Apparatus for aeroponically growing and developing plants |
| 8,216,971 | Pesticide composition comprising propamocarb-hydrochloride and an |
| | insecticide active substance |
| 8,186,100 | Photovoltaic greenhouse structure |
| D658,537 | Vertical aeroponic growing tower |
| 8,122,643 | Method and apparatus for growing plants |
| 7,985,435 | Triterpene compositions and methods for use thereof |
| 7,966,767 | Enhanced plant growth using alkane biostimulation |
| 7,877,927 | Modular aeroponic/hydroponic container mountable to a surface |
| 7,842,264 | Process and apparatus for carbon capture and elimination of multi-pollutants in |
| | flue gas from hydrocarbon fuel sources and recovery of multiple by-products |
| 7,823,328 | Aeroponic plant growing system |
| 7,811,352 | Fertilizer compositions and methods of using |
| 7,776,124 | Fertilizer compositions and methods of using |
| 7,670,632 | Triterpene compositions and methods for use thereof |
| 7,641,132 | Dispersion and aeration apparatus for compressed air foam systems |
| 7,621,129 | Power generation system |
| D604,196 | Indoor gardening appliance |
| 7,426,802 | Seed germination and paint supporting utility |
| 7,350,331 | Method for producing metabolites from plants cultivated in soil-less medium |
| 7,328,532 | Method and a kit for shaping a portion of a woody plant into a desired form |
| 7,192,523 | Methods for treating agricultural waste and producing plant growth-enhancing |
| | material |
| 7,181,886 | Orbital hydroponic or aeroponic agricultural unit |
| 7,105,186 | Triterpene compositions and methods for use thereof |
| 7,057,023 | Methods and apparatus for spinning spider silk protein |
| 7,022,524 | Increasing plant growth with luminol |
| 6,962,720 | Triterpene compositions and methods for use thereof |
| 6,957,512 | Method for the propogation of and aeroponic growing of plants and vessels |
| | therefor |
| 6,849,777 | LNP, a protein involved in the initiation of mycorrhizal infection in plants |
| 6,837,002 | Tray for hydroponic and aeroponic cultivation |
| 6,807,770 | Low pressure aeroponic growing apparatus |
| 6,759,232 | Method of facilitating mass production and sporulation of arbuscular |
| | mycorrhizal fungi aseptic in vitro |
| 6,746,696 | Triterpene compositions and methods for use thereof |
| 6,719,488 | Soil pf value measuring method, and irrigation control method and irrigation |
| | control device |
| 6,689,398 | Triterpene compositions and methods for use thereof |
| 6,544,789 | Phosphorus-controllable recombinant expression of polypeptides in plants |
| 6,508,033 | Self contained fully automated robotic crop production facility |
| 6,444,233 | Triterpene compositions and methods for use thereof |
| 6,365,406 | Enhancers of net photosynthesis and methods of enhancing net photosynthesis |
| 6,324,785 | Process for harvesting organic compounds from plant roots |
| 6,314,675 | Air culture system comprising a management system |
| 6,276,089 | Chamber for aeroponic culture |
| 6,270,809 | Nutritional supplements |
| 6,243,987 | Self contained fully automated robotic crop production facility |
| 6,219,966 | Container for hydroponic culture and method for making same |
| 6,096,546 | Methods for recovering polypeptides from plants and portions thereof |
| 6,080,222 | Organic liquid nutrition source for plants and manufacturing method for same |
| 6,070,358 | Seed germination system |
| 6,065,245 | Integrated aquaculture-hydroponics systems: nutrient dynamics and designer |
| | diet development |
| 6,021,602 | Modular structure for aeroponic cultivations |
| 6,000,173 | Hydroponic growing station with intermittent nutrient supply |
| 5,937,575 | Aeroponic growth system with nutrient fog stabilization |
| 5,918,416 | Aeroponic plant growth apparatus and method |
| 5,876,484 | Method for removing soluble metals from an aqueous phase |
| D402,668 | Aeroponic plant grower with plant support |
| D402,296 | Aeroponic plant grower |
| D402,230 | Support for supporting plants for aeroponic treatment |
| D397,280 | Aeroponic plant grower housing cover with seed support screens |
| 5,724,768 | Aeroponic plant growth apparatus and method |
| 5,648,598 | Ornamental character of scented geraniums by genetic transformation |
| 5,589,437 | Method of using 5-hydroxybenzimidazole compounds for reducing transpiration |
| | in plants |
| 5,501,037 | Hydroponics process and device |
| 5,393,426 | Method for removing soluble metals from an aqueous phase |
| 5,300,260 | Fog generator |
| 5,136,804 | System for germination, propagation and growing plants in ultrasonic-fog |
| | conditions (aeroponics) |
| 5,096,481 | Sheared roots as a VA-mycorrhizal inoculum and methods for enhancing plant |
| | growth |
| 4,869,019 | Aeroponic apparatus |
| 4,813,176 | Aeroponic apparatus |
| 4,721,250 | Method and apparatus for effecting control of atmospheric temperature and |
| | humidity |
| 4,669,217 | Plant propagation system and apparatus |
| 4,584,791 | Soiless agricultural system and components therefore |
| 4,514,930 | Method and apparatus for aeroponic propagation of plants |
| 4,332,105 | Apparatus and method for plant growth in aeroponic conditions |

The aforementioned prior art encompasses prior uses or conjunctive uses of aeroponics or aeroponic. The specification and drawings describe an invention vastly superior and differentiable to an extent that the only common trait is the used name of Aeroponics or Aeroponic. Otherwise the benefits will be evidently clear after close examination by a person sufficiently trained within this field of knowledge.

The main objective of this invention is to precisely control the application of a mist of nutrient solution, or various other solutions as detailed within, to the root zone of an organism or an entire organism itself. The main advantage of this invention is highly branched root zone, or a fuzzy root, that contains multiple root hairs that ultimately increase the surface area of the root zone allowing for a more efficient uptake of nutrients and water. While the aforementioned is stated in simplified terms, and may not describe all objectives and advantages in full, the specifications in its entirety encompasses a more thorough and detailed explanation of the objectives and advantages.

### BRIEF SUMMARY OF THE INVENTION

This invention is in contrast to existing aeroponic and hydroponic systems that rely on devices such as pumps, accumulator tanks, valves, sensors, timers, sprayers, and nozzles in varying combinations and of varying types to deliver a nutrient solution to the root zone of an organism or directly to an organism. Typically aeroponic and hydroponic systems rely on devices such as pumps, accumulator tanks, valves, sensors, timers sprayers, and nozzles etc. . . . in varying combinations and of varying types to deliver a nutrient solution to the root zone of an organism or directly to an organism to provide the necessary nutrients and water. In Aeroponics the cycle of the delivery of a spray of nutrient solution that contains nutrients or fertilizers is that of a duration of an approximate range of >˜1 one second, this is followed by a static off time typically in the 1½ minute range. However both of the on and off cycles may be of a longer duration. In this method of aeroponics the cycle is neither precise nor efficient. The complex system aforementioned does not address all the needs associated with the production of an organism and carry an increased cost associated with development, manufacturing, the final point of purchase, additional equipment needed for the production of an organism, a decrease of performance, and a decrease in efficiency.

### BRIEF DESCRIPTION OF THE SEVERAL VIEWS OF THE DRAWING(S)

FIG. 1. is a side view of an organism, in this case a mock plant, used as a model organism for the explanation of the invention;

FIG. 2. is a side view of the of the mock apparatus and model organism used for the explanation of the invention;

FIG. 3. is a side cross-section view of mock apparatus, without the delivery of a precise pulse of aerosol, and model organism, in this case a mock plant, used for the explanation of the invention;

FIG. 4. is a side cross-section view of the inside of the mock apparatus, without the delivery of a precise pulse of aerosol, and model organism, in this case a mock plant, used for the explanation of the invention;

FIG. 5. is a side cross-section view of the inside of the mock apparatus, with the delivery of a precise pulse of aerosol, and model organism, in this case a mock plant, used for the explanation of the invention;

FIG. 6. is a side cross-section view of the inside of the mock apparatus, without the delivery of a precise pulse of aerosol, and model organism, in this case a mock plant with an advanced root structure, used for the explanation of the invention; and

FIG. 7. is a side view of an organism, in this case a mock plant with an advanced root structure, used as a model organism used for the explanation of the invention.

### DETAILED DESCRIPTION OF THE INVENTION

An invention described as a method wherein an apparatus capable of delivering a nutrient solution, i.e. pumps, accumulator tanks, valves, sensors, timers, computers, tanks, containers, sprayers, and nozzles etc. . . . in varying combinations and of varying types, is controlled in any manner to produce a precise pulse of an aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned to the root zone of an organism or directly to an organism. In this method there is a precise period of the absence of the aerosol following the precise pulse of the aerosol and the cycle is repeated. Multiple nozzles can be used to fulfill any problems where the volume of aerosol needed would result in requiring a longer burst and as a result not an even distribution of a precise pulse, rather just aeroponics. In this context aerosol is the equivalent to but not only inclusive of an atomized liquid, mist, spray, fog, or a liquid dispersed in a gas and the ideal characteristics are further explained bellow and within the specifications. Traditionally the term nutrient solution would be used to describe the liquid that is ultimately sprayed, misted or otherwise delivered to the root zone of an organism or an organism directly but a more accurate term is a an aerosol containing a colloid, or a solution, or a combination of a colloid and a solution wherein the aforementioned colloid, or solution, or combination of a colloid and a solution is constructed containing nutrients, or fertilizers, or a varying combination of the dispersed phase in the continuous phase, or a varying combination of solutes in a solvent, or a varying combination of the aforementioned. The term organism should not be construed as a limiting term but rather as a broad term for any portion of an organism, such as tissue, or an organism in the dormant state, such as a seed, or an organism that may be a part of a colony, such as a colony of bacteria or algae, or anything that may be termed an organism or is comparable to an organism in nature, such as viruses and protocells. This invention is a method wherein an apparatus is constructed and/or controlled in any manner to produce a precise pulse of an aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned to the root zone of an organism or directly to an organism, this method can be incorporated and/or retrofitted and used in conjunction with any existing aeroponic system, hydroponic system or can be incorporated into newly designed systems. The pulse of the aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned should consist of a volume and particulate size, i.e. water droplet size in the range of microns but not only inclusive of only micron particulates or liquids, sufficient enough to cover and penetrate the root zone of an organism or directly cover an organism, that is to provide enough coverage and penetration to fully allow for the aforementioned aerosol to be applied to all surfaces of the root zone of an organism or directly cover an entire organism, but not be of such a force to cause damage to any tissue of the root zone of an organism or directly damage tissue of an organism, or an organism itself, unless such damage has a purposeful use (e.g. transfer of genetic material through mechanical means or cleaning/scouring of tissue surfaces.)

The implementation of this invention may include but is not limited to an apparatus, i.e. pumps, accumulator tanks, valves, sensors, timers, computers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, that may be compartmentalized within the system, i.e. self-contained as a stand-alone unit, or be decentralized, i.e. various components that are not located in the same area but still comprise of a system, or be constructed as a mixture of both compartmentalized and decentralized, i.e. some components are self-contained as a stand-alone unit and some components are not located in the same area but are still comprise of a system. The compartmentalization of the components of the apparatus allows for a modular system, in which each stand-alone unit comprises of all necessary equipment, i.e. pumps, accumulator tanks, valves, sensors, timers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, to operate on its own. This method increases the reliability of the system in that a failure of a component is limited to a single system. The decentralization of the components of the apparatus allows for a modular system, in which each stand-alone unit comprises of all necessary equipment, i.e. pumps, accumulator tanks, valves, sensors, timers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, to operate when various components are not located in the same area but still are comprised of a system. This increases the efficiency of the system in that redundancy of a component is limited to a single system. The mixture of the components of the apparatus as both compartmentalized and decentralized, i.e. some components are self-contained as a stand-alone unit and some components are not located in the same area but still are comprised of a system, allows for a modular and decentralized system, in which each stand-alone unit comprises of all necessary equipment, i.e. pumps, accumulator tanks, valves, sensors, timers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, allowing for the benefits of both the compartmentalized and decentralized system.

The implementation of this invention is a method that may include but is not limited to an apparatus, i.e. pumps, accumulator tanks, valves, sensors, timers, computers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, may be used in either a vertical array, that is where plants grown vertically, a horizontal array, that is where plants grown horizontally, or any combination of the aforementioned.

This invention is a method and the implementation of this method may include but is not limited to an apparatus, i.e. pumps, accumulator tanks, valves, sensors, timers, computers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; is compared to forms of agriculture that do not precisely control a pulse of nutrient solution such as traditional agriculture, i.e. where plants are grown in soil, hydroponics, i.e. where plants are grown in a media and/or a nutrient solution for a continuous or intermittent amount of time, or aeroponics, i.e. where plants are sprayed with a nutrient solution for a continuous or intermittent amount of time. This method increases the surface area of the active root zone through a precisely controlled pulse of nutrient solution, the controlled pulse of the nutrient solution induces a geometric change within the root zone causing the root zone to increase the number of individual root hairs. This is in contrast to traditional agriculture, where plants are grown in soil, hydroponics, where plants are grown in a media and/or a nutrient solution for a continuous or intermittent amount of time, or aeroponics, where plants are sprayed with a nutrient solution for a continuous or intermittent amount of time, where the plants roots are subjected to an amount of nutrient solution that hinders root hair development. The application of nutrient solution as described for traditional agriculture and specifically aeroponics or hydroponics will cause the root zone mass to increase; however a portion of root zone is no longer active, the root zone is undergoing cell apoptosis due to the restriction of oxygen available, there is a decreases plant growth performance and size due to the energy and consumption of vital elements and compounds needed to grow the root mass, there is a decrease in nutrient absorption because of the limited surface area of the active root zone, and there is an increase associated cost due to the need of additional nutrients, fertilizers, water, equipment, i.e. water coolers or air pumps, resources, time, and due to the loss of product or underutilized product. The increase in the root hair development achieved through this method and the implementation of this method, that may include but is not limited to the implementation of an apparatus, i.e. pumps, accumulator tanks, valves, sensors, timers, computers, tanks, containers, sprayers, and nozzles etc. . . . in varying combinations and of varying types, that is controlled in any manner to produce a precise pulse of precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned,

This invention is a method, that may include but is not limited to the implementation of an apparatus, allows for the reduction of waste water, this is achieved through limiting the water that needs to be applied through increasing absorption by increasing the active root zone surface area. This method allows for the reduction of waste fertilizers/nutrients, this is achieved through limiting the fertilizers/nutrients that needs to be applied through increasing absorption by increasing the active root zone surface area. This invention allows for an increase in plant performance and growth, this is achieved through increasing the absorption of water, fertilizers, and nutrients by increasing the active root zone surface area. This invention allows for an increase in plant size, this is achieved through increasing the absorption of water, fertilizers, and nutrients by increasing the active root zone surface area. This invention allows for a decrease in the amount of time needed to reach the desired maturity of a plant, this is achieved through increasing the absorption of water, fertilizers, and nutrients by increasing the active root zone surface area. This invention allows for an increase in plant size, this is achieved through increasing the absorption of water, fertilizers, and nutrients by increasing the active root zone surface area. This invention allows for the reduction in damage to any tissue of the root zone of an organism or directly damage tissue of an organism, unless such damage has a purposeful use (e.g. transfer of genetic material through mechanical means or cleaning/scouring of tissue surfaces.) This invention allows for an increase in monetary gain through reducing cost associated with production, reducing the time needed for a plant to reach the desired maturity, and by increasing plant size, this is achieved through increasing the absorption of water, fertilizers, and nutrients by increasing the active root zone surface area.

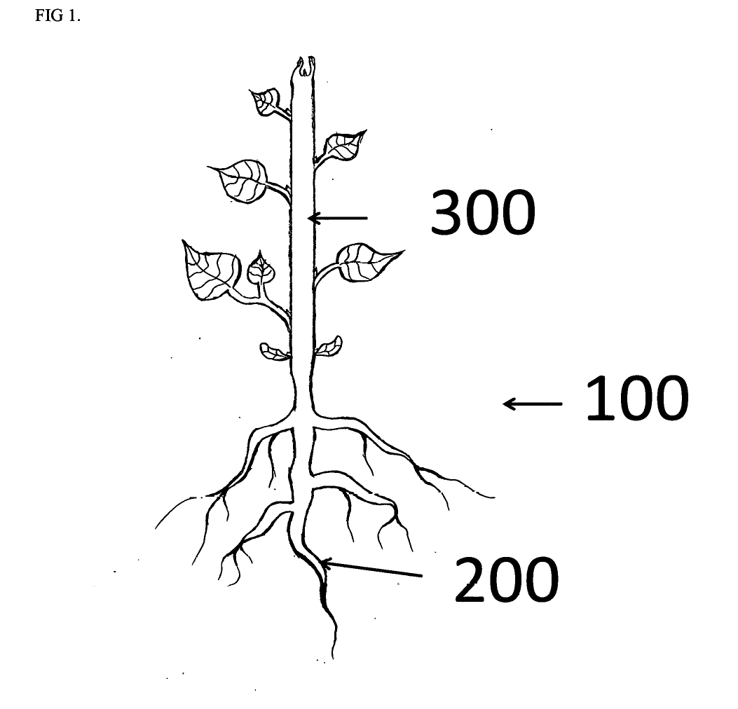

Referring to the invention explained in more detail, in FIG. 1. there is shown a model organism 100, consisting of a root zone 200 and a stem with leafs 300.

In further detail, still referring to the explanation of the invention in FIG. 1., the model organism 100 is a mock plant that is a stereotypical representation of a plant with the root zone 200 and the stem with leafs 300.

The details of the invention shown in FIG. 1, are that the model organism 100 is a mock plant, however this is used to convey the method and is not to be construed as the only organism that is acceptable for use and that a wide range of organisms, including but not limited to seeds, tissue, cells, would be acceptable for use.

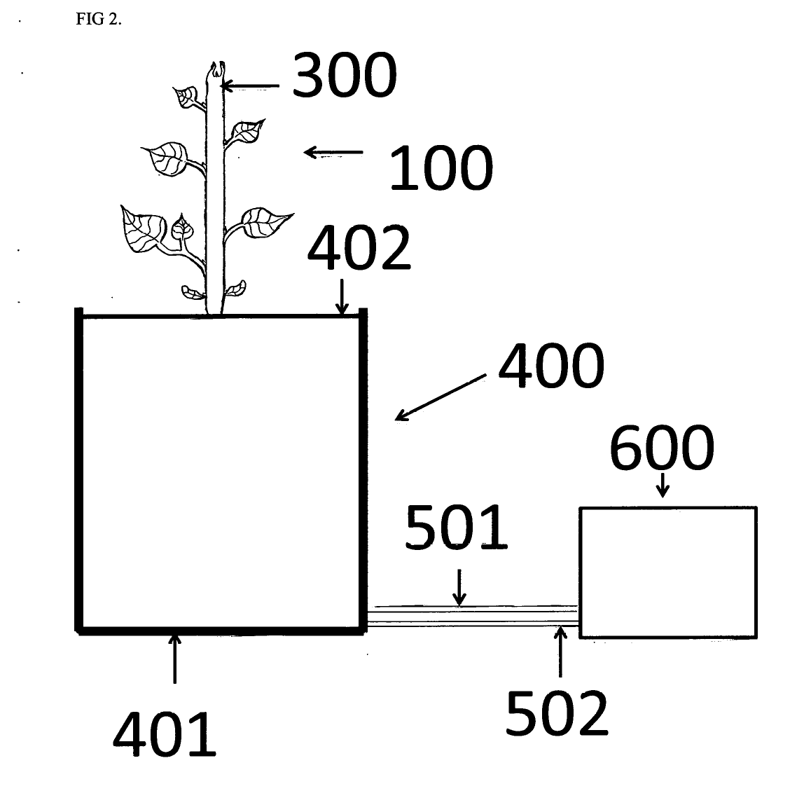

Now referring to FIG. 2, the model organism 100, consisting of the stem with leafs 300 protruding out from a container 400. The container 400 has a bottom portion 401 and a lid 402. The container 400 is supplied by a supply tube 501 and drained by a drain tube 502, both are connected to a pumping station 600 and the container 400.

In further detail, still referring to the invention in FIG. 2, The pumping station 600 is capable of controlling and delivering the precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; within the container 400 via the supply tube 501. The pumping station 600 is also capable of receiving any drainage from the container 400 for further processing via the drain tube 502.

The details of the invention shown in FIG. 2, are that the model organism 100 is a mock plant, however this is used to convey the method and is not to be construed as the only organism that is acceptable for use and that a wide range of organisms, including but not limited to seeds, tissue, cells, would be acceptable for use. The pumping station 600 is used as a representation for an apparatus capable of delivering the precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; within the container 400 and is not limited to the description of the pumping station 600 but is inclusive of any and all apparatus that is capable of producing or aiding in the production of precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned. The pumping station 600 is used as a representation for an apparatus capable of controlling the delivery of the precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; within the container 400 and is not limited to the description of the pumping station 600 but is inclusive of any and all apparatuses that are capable of controlling or aiding in the control of the supply of the precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned. The supply tube 501 and the drain tube 502 are used as a representation for an apparatus that is capable of supplying and draining a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; from the container 400 to the pumping station 600 and is not limited to the description of the supply tube 501 and the drain tube 502 but is inclusive of any and all apparatus that is capable of respectively supplying or draining the precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned.

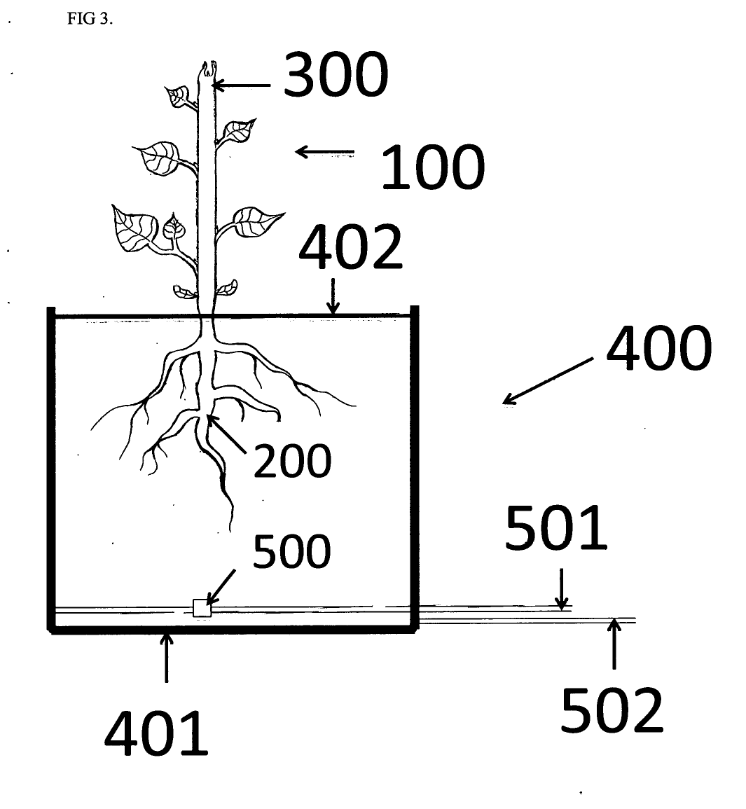

Now referring to FIG. 3, the model organism 100, consisting of the root zone 200 shown contained within the container 400 and the bottom portion 401; and the stem with leafs 300 protruding out from the container 400 and the lid 402. The container 400 has the bottom portion 401 and the lid 402. The container 400 is supplied by the supply tube 501 and drained the drain tube 502. The supply tube 501 passes through the container 400 and supplies a nozzle 500. The drain tube 502 is connected to the container 400.

In further detail, still referring to the invention in FIG. 3, the nozzle 500 delivers the precise pulse of aerosol to the root zone 200 of the model organism 100 contained within the container 400. The drain tube 502 drains any superfluous fluids or matter. The supply tube 501 supplies the nozzle 500 with a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; for use in the aerosol.

The details of the invention shown in FIG. 3, are that the model organism 100 is a mock plant, however this is used to convey the method and is not to be construed as the only organism that is acceptable for use and that a wide range of organisms, including but not limited to seeds, tissue, cells, would be acceptable for use. The nozzle 500 is used as a representation for an apparatus capable of delivering the precise pulse of an aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; within the container 400 and is not limited to the description of the nozzle 500 but is inclusive of any apparatus that is capable of producing or aiding in the production of precise pulse of an aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned. The supply tube 501 and the drain tube 502 are used as a representation for apparatuses that are capable of respectively supplying and draining a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; from and to the container respectively and is not limited to the description of the supply tube 501 and the drain tube 502 but is inclusive of any and all apparatus that is capable of respectively supplying and draining the precise pulse of a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned.

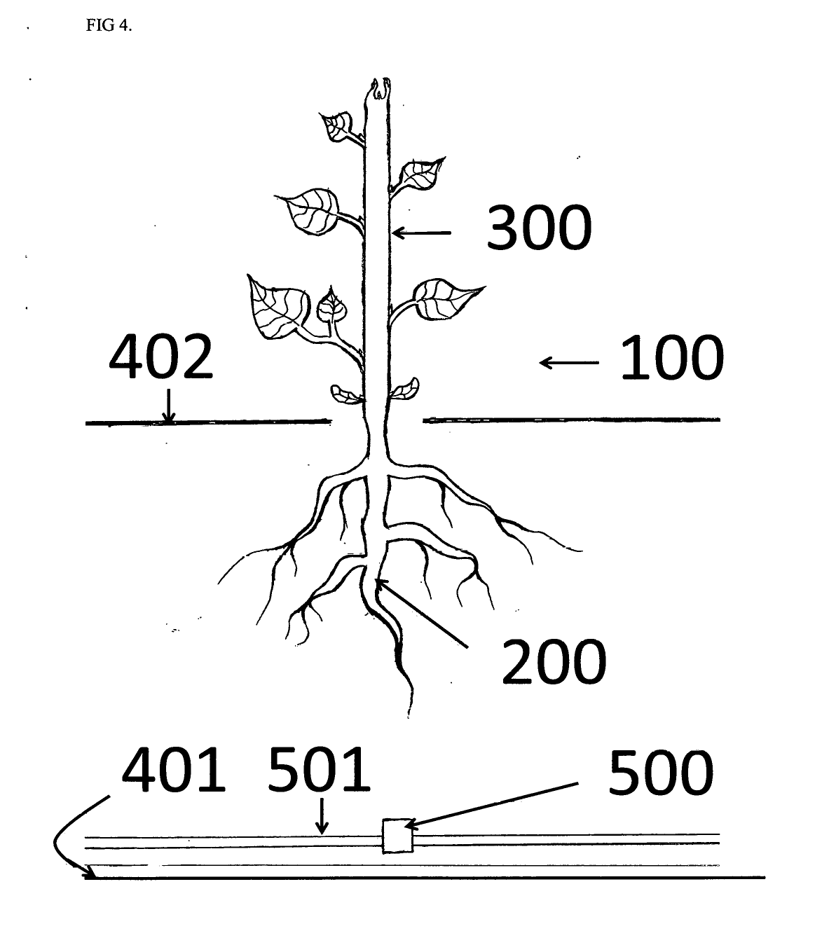

Now referring to FIG. 4, the model organism 100, consisting of the root zone 200 shown contained within the bottom portion 401 and the stem with leafs 300 protruding out through the lid 402. The supply tube 501 supplies the nozzle 500.

In further detail, still referring to the invention in FIG. 4, the nozzle 500 supplies the precise pulse of aerosol, to the root zone 200 of the model organism 100 contained within the bottom portion 401 and the contents are contained by the lid 402. The supply tube 501 supplies the nozzle 500 with a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; for use in the aerosol.

The details of the invention shown in FIG. 4, are that of a representational step of the method. In this scenario the model organism 100 may be that of a transplant from an existing stock (i.e. a plant from another aeroponics or hydroponic system) is already semi-mature with the root zone 200 and stem with leafs 300 already formed and is in the primary step. The nozzle 500, that delivers the precise pulse of aerosol to the root zone 200, is not producing a precise pulse of aerosol. This is a representation of the primary step but should not be considered to be the only implementation of this method as the initial primary step may vary and should be inclusive of any adaptations of the method as a whole.

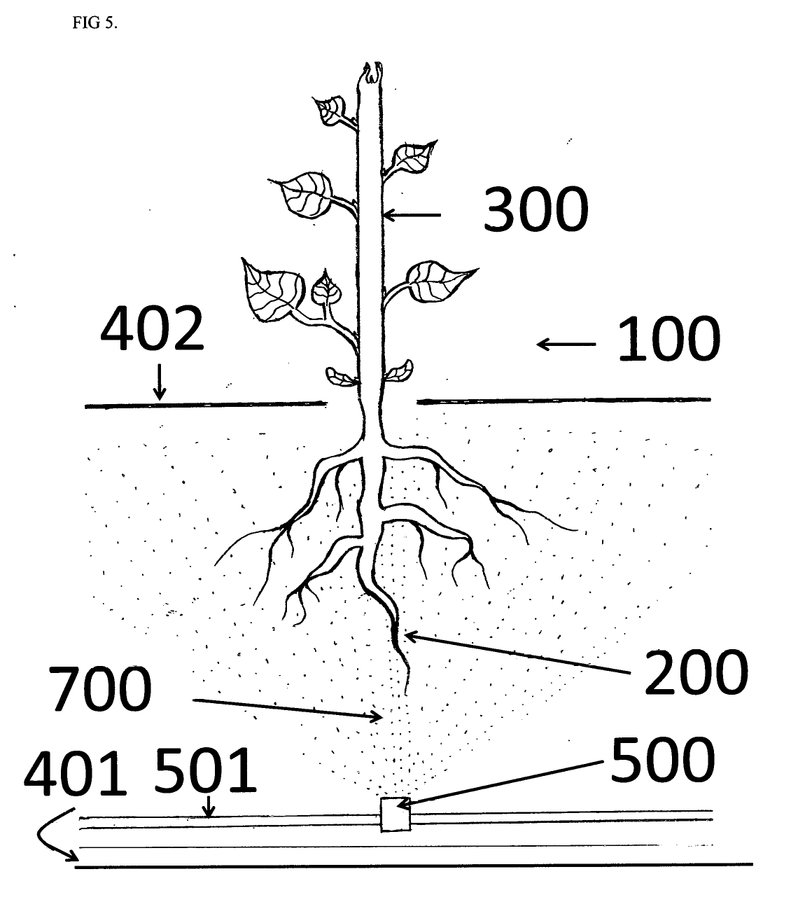

Now referring to FIG. 5, the model organism 100, consisting of the root zone 200 shown contained within the bottom portion 401 and the stem with leafs 300 protruding out through the lid 402. The supply tube 501 supplies the nozzle 500. The nozzle 500 produces an aerosol 700.

In further detail, still referring to the invention in FIG. 5, the nozzle 500 supplies the precise pulse of the aerosol 700, to the root zone 200 of the model organism 100 contained within the bottom portion 401 and the contents are contained by the lid 402. The supply tube 501 supplies the nozzle 500 with a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; the nozzle 500 produces an aerosol 700 from this supply.

The details of the invention shown in FIG. 5, are that of a representational step of the method. In this scenario the model organism 100 may be that of a transplant from an existing stock (i.e. a plant from another aeroponics or hydroponic system) is already semi-mature with the root zone 200 and stem with leafs 300 already formed and is in the secondary step. The nozzle 500, that supplies the precise pulse of aerosol to the root zone 200, is producing a precise pulse of the aerosol 700. The duration of time that the precise pulse of the aerosol 700 is produced form the nozzle 500 is of a duration of time in tenths, hundredths, thousandths or sub-thousandths of a second and sufficient enough to cover, penetrate and transfer the contents of the aerosol to the root zone 200. That is to provide enough coverage and penetration to fully allow for the aerosol 700 to be applied and transfer the contents of the aerosol to the root zone 200 but is not be of such a duration of time to cause over saturation, or over accumulation, or damage to the tissue of the root zone 200, unless such over saturation, or over accumulation, or damage has a purposeful use. This is a representation of the secondary step but should not be considered to be the only implementation of this method as the secondary step may vary and should be inclusive of any adaptations of the method as a whole.

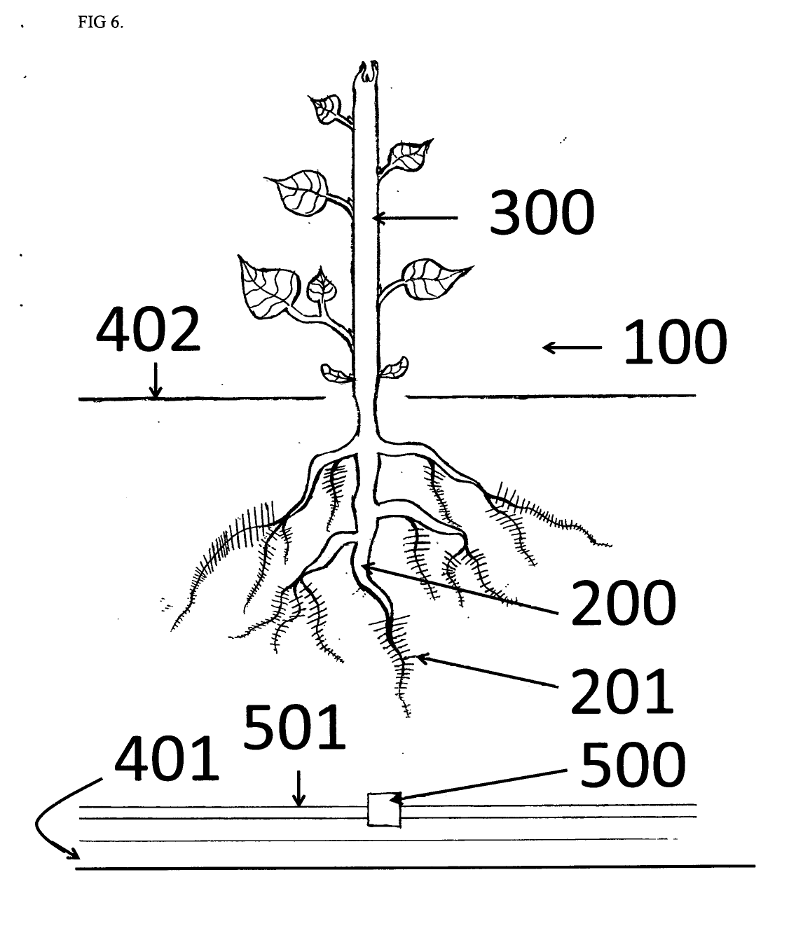

Now referring to FIG. 6. the model organism 100, consisting of the root zone 200 shown contained within the bottom portion 401 and the stem with leafs 300 protruding out through the lid 402. The supply tube 501 supplies the nozzle 500. The root zone 200 now contains an advanced root structure 201.

In further detail, still referring to the invention in FIG. 6, the nozzle 500 supplies the precise pulse of the aerosol, to the root zone 200 of the model organism 100 contained within the bottom portion 401 and the contents are contained by the lid 402. The supply tube 501 supplies the nozzle 500 with a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned; the nozzle 500 is capable of producing an aerosol.

The details of the invention shown in FIG. 6, are that of a representational step of the method. In this scenario the model organism 100 may be that of a transplant from an existing stock (i.e. a plant from another aeroponics or hydroponic system) is already semi-mature with the root zone 200 and stem with leafs 300 already formed and is in the tertiary step. The nozzle 500, that supplies the precise pulse of aerosol to the root zone 200, is not producing a precise pulse of aerosol. In this step of the method the absence of the aerosol is that of a duration of time brief enough to not allow the drying out of the root zone of an organism but is sufficient enough that over saturation, or over accumulation does not occur unless such over saturation, or over accumulation, or damage has a purposeful use. The root zone 200 now contains the advanced root structure 201. The cycling of the off and on of the precise pulse would be repeated. This is a representation of the tertiary step but should not be considered to be the only implementation of this method as the tertiary step may vary and should be inclusive of any adaptations of the method as a whole.

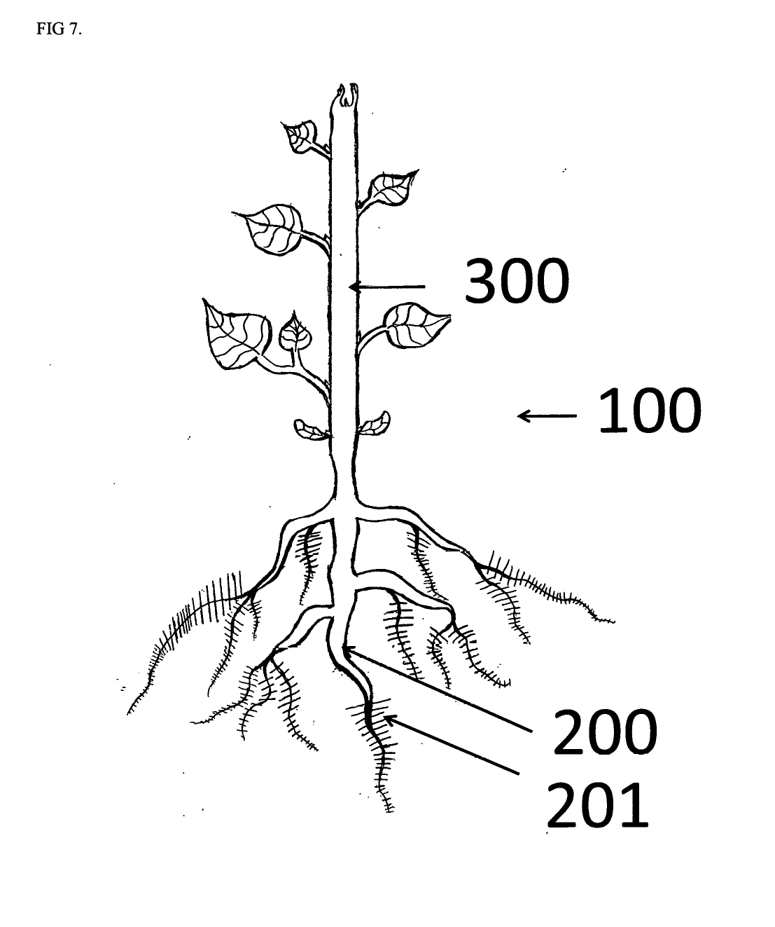

Now referring to FIG. 7. the model organism 100, consisting of the root zone and the stem with leafs 300. The root zone 200 now contains the advanced root structure 201.

This method may be implemented in various ways and in incremental steps or by an apparatus of varying components, materials and be a multitude of sizes and shapes. For instance the method could be implemented as a precise pulse of an aerosol that is of a duration of time in tenths, hundredths, thousandths or sub-thousandths of a second and is sufficient to cover, penetrate and transfer the contents of the aerosol to the root zone of an organism or directly cover an organism and does not cause over saturation or damage unless intended.

The advantages of the aforementioned present invention include, without limitation, allow for the precise pulse of an aerosol delivered to the root zone of an organism or to an organism directly. This method increases the surface area of the active root zone through a precisely controlled pulse of nutrient solution, the controlled pulse of the nutrient solution induces a geometric change within the root zone causing the root zone to increase the number of individual root hairs. Through the use of this method a substantial positive impact is derived due to the reduction in operating costs, ease of use, and increase in profitability.

### Operation of Preferred Embodiment

In broad embodiment, the present invention is capable of producing a precise pulse of nutrient solution to the root zone of an organism or directly to an organism. The best practice of operation is a precise pulse of nutrient solution to the root zone of an organism or directly to an organism for a time interval long enough for coverage of the active root zone to occur, to supply the active root zone with water, fertilizers and/or nutrients, providing uniform coverage, and limiting any unnecessary coverage. The pulse of the nutrient solution should consist of a volume and particulate size, i.e. water droplet size in microns, sufficient enough to cover and penetrate the root zone of an organism or directly cover an organism, that is to provide enough coverage and penetration to fully allow for the nutrient solution to be applied to all surfaces of the root zone of an organism or directly cover an entire organism, but not be of a volume to counteract or interfere in the formation of root hairs or the uptake of oxygen and not be of such a force to cause damage to any tissue of the root zone of an organism or directly damage tissue of an organism, unless such damage has a purposeful use (e.g. transfer of genetic material through mechanical means or cleaning/scouring of tissue surfaces.)

### Description of Additional Embodiment

In an additional embodiment, the present invention is a method of controlling and delivering a precise pulse of solution containing solvent, cleaning agents, sterilization agents, chemical agents, biochemical agents, genetic materials, a mixture of the aforementioned agents and materials or any inert, organic or active compound, or mixtures of any inert, organic or active compounds in solution comprising of any solvent to the root zone of an organism or directly to an organism

### Operation of Additional Embodiment

In an additional embodiment, the additional operation of the present invention is a method of controlling and delivering a precise pulse of solution containing solvents, cleaning agents, sterilization agents, chemical agents, biochemical agents, genetic materials, a mixture of the aforementioned agents and materials or any inert, organic or active compound, or mixtures of any inert, organic or active compounds in solution comprising of any solvent; may be that of which the time interval, volume, particulate size, force of the delivery of the solution and solution composition may vary as is necessary to achieve the desired function of the solution

### CONCLUSION, RAMIFICATION, AND SCOPE

In the broad embodiment the present invention, is a method wherein a precise pulse of nutrient solution is delivered to the root zone of an organism or directly to an organism. Further the present invention must not necessarily be used only with nutrients or fertilizers in solution but could be a varying combination of solutes in a solvent to produce desired results and may be that of which the time interval, volume, particulate size, force of the delivery of the solution and solution composition may vary as is necessary to achieve the desired function of the solution, but itself is not a hydroponics, or aeroponics as previously defined as an inefficient spray, or traditional agriculture.

The aforementioned written description of the present invention enables one in the given technical field and of ordinary skill to recreate what is stated as the best mode and should therefore be stated that those of ordinary skill would comprehend and grasp alterations, combinations of alterations and variations, and parallel incorporations of specific embodiments, examples and methods. Therefore the aforementioned written and drawn description of the present invention should not be limited by the described embodiment, examples and methods but should be encompassed by the scope and spirit of any and all embodiments, examples and methods.

### SEQUENCE LISTING OR PROGRAM

Not applicable

1. An invention of industrial aeroponics comprising: delivering a precise pulse of an aerosol containing a colloid, or a solution, or a combination of a colloid and a solution to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; abstaining from delivering a precise pulse of an aerosol containing a colloid, or a solution, or a combination of a colloid and a solution to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; repeating the aforementioned cycle.

2. The invention of claim 1 further comprising of delivering a precise pulse of an aerosol containing a colloid, or a solution, or a combination of a colloid and a solution wherein the aforementioned colloid, or solution, or combination of a colloid and a solution is constructed containing nutrients, or fertilizers, or a varying combination of the dispersed phase in the continuous phase, or a varying combination of solutes in a solvent, or varying combinations of nutrients, of fertilizers, of a varying combination of the dispersed phase in the continuous phase, of a varying combination of solutes in a solvent.

3. The invention of claim 2 wherein delivering a precise pulse of an aerosol is of a duration of time, size, volume and force which is sufficient to cover, penetrate and transfer the contents of the aerosol to the root zone of an organism or directly cover an organism; that is to provide enough coverage and penetration to fully allow for the aforementioned aerosol to be applied to and transfer the contents of the aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; not be of such a duration of time, size, volume and force to cause over saturation, or over accumulation, or damage unless such over saturation, or over accumulation, or damage has a purposeful use; achieved by using a single apparatus capable of producing an aerosol or multiple apparatuses capable of producing an aerosol.

4. The invention of claim 3 wherein delivering a precise pulse of an aerosol is of a duration of time in tenths, hundredths, thousandths or sub-thousandths of a second and sufficient to cover, penetrate and transfer the contents of the aerosol to the root zone of an organism or directly cover an organism; that is to deliver a precise pulse of an aerosol for a duration of time that provides enough coverage and penetration to fully allow for the aforementioned aerosol to be applied and transfer the contents of the aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; not be of such a duration of time to cause over saturation, or over accumulation, or damage unless such over saturation, or over accumulation, or damage has a purposeful use; achieved by using a single apparatus capable of producing an aerosol or multiple apparatuses capable of producing an aerosol.

5. The invention of claim 4 wherein delivering a precise pulse of an aerosol is in a size in the micrometer range, sub-micrometer range, above the micrometer, or a varying range of the aforementioned and is sufficient to cover, penetrate and transfer the contents of the aerosol to the root zone of an organism or directly cover an organism; that is to deliver a precise pulse of an aerosol in a size that provides enough coverage and penetration to fully allow for the aforementioned aerosol to be applied and transfer the contents of the aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; not be of such a size to cause over saturation, or over accumulation, or damage unless such over saturation, or over accumulation, or damage has a purposeful use; achieved by using a single apparatus capable of producing an aerosol or multiple apparatuses capable of producing an aerosol.

6. The invention of claim 5 wherein delivering a precise pulse of an aerosol is of a volume that is sufficient to cover, penetrate and transfer the contents of the aerosol to the root zone of an organism or directly cover an organism; that is to deliver a precise pulse of an aerosol of a volume that provides enough coverage and penetration to fully allow for the aforementioned aerosol to be applied and transfer the contents of the aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; not be of such a volume to cause over saturation, or over accumulation, or damage unless such over saturation, or over accumulation, or damage has a purposeful use; achieved by using a single apparatus capable of producing an aerosol or multiple apparatuses capable of producing an aerosol.

7. The invention of claim 6 wherein delivering a precise pulse of an aerosol is of a force that is sufficient to cover, penetrate and transfer the contents of the aerosol to the root zone of an organism or directly cover an organism; that is to deliver a precise pulse of an aerosol of a force that provides enough coverage and penetration to fully allow for the aforementioned aerosol to be applied and transfer the contents of the aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; not be of such a force to cause over saturation, or over accumulation, or damage unless such over saturation, or over accumulation, or damage has a purposeful use; achieved by using a single apparatus capable of producing an aerosol or multiple apparatuses capable of producing an aerosol.

8. The invention of claim 7 wherein the abstaining of delivering a precise pulse of aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; is a duration of time brief enough to not allow the drying out of a portion of the root zone of an organism, or the entire root zone of an organism, or a portion of organism, or an entire organism, or to a varying combination of a portion of the root zone of an organism, of the entire root zone of an organism, of a portion of organism directly, of an entire organism directly to occur; sufficient enough that over saturation, or over accumulation, or damage does not occur if the delivery of the precise pulse of an aerosol was to recommence after the abstaining period unless such over saturation, or over accumulation, or damage has a purposeful use.

9. The invention of claim 8 wherein the cycling of the abstaining and delivering of a precise pulse of aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; is controlled in a repeating fashion

10. The invention of claim 9 wherein the cycling of the abstaining and delivering of a precise pulse of aerosol to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly; is correlated to the requirements of the root zone of an organism or an organism.

11. The invention of claim 10 wherein the cycling of the abstaining and delivering of a precise pulse of aerosol is controlled by mechanical, or electrical, or electromechanical, or computer devices, or varying combinations of mechanical, of electrical, of electromechanical, of computer devices; connected to a single system, or a local area network, or wireless network, or data network, or communication network, or internet network, or varying combinations of a single system, of a local area network, of a wireless network, of a data network, of a communication network, of an internet network; connected to any system capable of transferring and receiving data; controlled with mechanical or electrical interfaces or varying combinations of mechanical interfaces, electrical interfaces; controlled with electronic devices remotely.

12. The invention of claim 11 wherein implementing this method may include but is not limited to an apparatus, i.e. pumps, accumulator tanks, valves, sensors, timers, computers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, that may be compartmentalized within the system, i.e. self-contained as a stand-alone unit, or be decentralized, i.e. various components that are not located in the same area but still comprise of a system, or be constructed as a mixture of both compartmentalized and decentralized, i.e. some components are self-contained as a stand-alone unit and some components are not located in the same area but are still comprise of a system. The compartmentalization of the apparatus allows for a modular system, in which each stand-alone unit comprises of all necessary equipment, i.e. pumps, accumulator tanks, valves, sensors, timers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, to operate on its own. This method increases the reliability of the system in that a failure of a component is limited to a single system. The decentralization of the apparatus allows for a modular system, in which each stand-alone unit comprises of all necessary equipment, i.e. pumps, accumulator tanks, valves, sensors, timers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, to operate when various components are not located in the same area but still are comprised of a system. This increases the efficiency of the system in that redundancy of a component is limited to a single system. The mixture of the apparatus as both compartmentalized and decentralized, i.e. some components are self-contained as a stand-alone unit and some components are not located in the same area but still are comprised of a system, allows for a modular and decentralized system, in which each stand-alone unit comprises of all necessary equipment, i.e. pumps, accumulator tanks, valves, sensors, timers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, allowing for the benefits of both the compartmentalized and decentralized system.

13. The invention of claim 12 wherein implementing this method may include but is not limited to an apparatus, i.e. pumps, accumulator tanks, valves, sensors, timers, computers, tanks, containers, sprayers, and nozzles etc. . . . in varying combinations and of varying types, that is controlled in any manner to produce a precise pulse of aerosol containing a colloid, or a solution, or a combination of a colloid and a solution wherein the aforementioned colloid, or solution, or combination of a colloid and a solution is a mixture containing nutrients, or fertilizers, or a varying combination of the dispersed phase in the continuous phase, or a varying combination of solutes in a solvent, or a varying combination of the aforementioned, may be used in either a vertical array, that is where plants grown vertically, a horizontal array, that is where plants grown horizontally, or any combination of the aforementioned.

14. An invention of industrial aeroponics comprising: delivering a precise pulse of an aerosol containing a colloid, or a solution, or a combination of a colloid and a solution to a portion of the root zone of an organism, or the entire root zone of an organism, or directly to a portion of organism, or directly to an entire organism, or to a varying combination of a portion of the root zone of an organism, of the entire root zone of an organism, of a portion of organism directly, of an entire organism directly.

15. The invention of claim 14 wherein the delivering of a precise pulse of an aerosol containing; genetic material for transformation, or viral vector for transduction, or organisms, or biomaterial, or bio-chemical material, or bio-chemical marker, or chemical agent or any varying combination of genetic material for transformation, of viral vector for transduction, of organisms, of biomaterial, of bio-chemical material, of bio-chemical marker, of chemical agent.

16. The invention of claim 15 wherein the delivering of a precise pulse of an aerosol that is of a force to allow for the injection of the of the aerosol into a portion of the root zone of an organism, or the entire root zone of an organism, or directly to a portion of organism, or directly to an entire organism, or into a varying combination of a portion of the root zone of an organism, of the entire root zone of an organism, of a portion of organism directly, of an entire organism directly.

17. An invention of industrial aeroponics comprising: delivering a precise pulse of an aerosol containing a colloid, or a solution, or a combination of a colloid and a solution to any living organism, a portion of a living organism, or to the tissue of an organism.

18. The invention of claim 17 wherein the method of delivering a precise pulse of an aerosol containing a colloid, or a solution, or a combination of a colloid and a solution to any living organism, a portion of a living organism, or to the tissue of an organism may be used in either a vertical array, that is where plants grown vertically, a horizontal array, that is where plants grown horizontally, or any combination of the aforementioned.

19. The invention of claim 18 wherein the method of delivering a precise pulse of an aerosol containing a colloid, or a solution, or a combination of a colloid and a solution to any living organism, a portion of a living organism, or to the tissue of an organism is controlled by electronics or mechanical devices.

20. The invention of claim 19 wherein the method of delivering a precise pulse of an aerosol containing a colloid, or a solution, or a combination of a colloid and a solution to any living organism, a portion of a living organism, or to the tissue of an organism is followed by a period of time before the precise pulse of an aerosol is repeated in a cycling manner.
